(19) United States
(12) Patent Application Publication
(10) Pub. No.: US 2019/0325483 A1
(43) Pub. Date: Oct. 24, 2019

(54) METHOD AND SYSTEM FOR DISPLAY OF A FILE ON A COMPUTING DEVICE

(71) Applicant: RENOWN MARKETING LIMITED, Ferrymead, Christchurch (NZ)

(72) Inventors: Chantal Natasha Uden, Christchurch (NZ); Philip Robert Uden, Christchurch (NZ); Steven James Uden, Christchurch (NZ); Han Jung Lu, Christchurch (NZ)

(21) Appl. No.: 16/312,728

(22) PCT Filed: Jun. 21, 2017
(86) PCT No.: PCT/IB2017/053677

§ 371 Date: Dec. 21, 2018

(30) Foreign Application Priority Data
Jun. 23, 2016 (NZ) 721376

(51) Int. Cl. G06Q 30/02

(52) U.S. Cl. CPC G06Q 30/0272; G06Q 30/0267; G06Q 30/0226

(57) ABSTRACT

A method of displaying a file on a screen of a computing device, including: establishing a communications link with a remote server, said server hosting at least one hosted electronic file; downloading from the remote server at least one hosted electronic file, and storing said hosted electronic file or files on a memory of the computing device as a stored electronic file or files; displaying a stored electronic file on the screen of the computing device when the computing device is displaying a home screen, or for a preselected time interval whenever a new application is launched on the computing device.

### TECHNICAL FIELD

The present invention provides a system for display of a file on a display screen of a computing device. In one particular example, it provides a system for displaying advertisements on the screen of a smart phone.

### BACKGROUND

Any discussion of the prior art is not an admission that such art forms part of the common general knowledge in the field.

US 2015/0039440 A1 describes a method of displaying an ad on a screen of a mobile device, m which includes the step of creating an ad request, transmitting the ad request to a server, and displaying an ad if there is a response from the ad server. The ad request may be based in part on the location of mobile device, user information, and device information.

WO 2014/011798 A1 describes a method of displaying an ad on either a lock screen or a splash screen on a portable electronic device, including the steps of transmitting user data to an advertising-selecting server, selecting an advertisement, transmitting the selected advertisement to the portable electronic device, and displaying the advertisement. The advertisement may be displayed on a splash screen displayed after a user has selected an unlock function on a lock screen.

WO 2006/116580 A2 describes a pop-up software application which displays changing content on a minor portion of the user's monitor screen. The display location may be preset. The pop-up window remains visible for a pre-selected time interval, and then closes. The user may specify settings such as the duration between pops up, and an interval until the pop up closes. The content changes each time the pop up appears. If the computer is not online, the content is sourced from the computer.

It is an object of the present invention to overcome at least one of the disadvantages of the prior art, or at least provide the public with a useful choice.

### Definition

As used herein, the term “computing device” means any device having a display screen, processor, memory and communications device, including desktop computers, laptops, tablets, mobile phones and smart phones.

### DISCLOSURE OF INVENTION

Therefore the present invention provides a method of displaying a file on a screen of a computing device, including:

establishing a communications link with a remote server, said server hosting at least one hosted electronic file;

downloading from the remote server at least one hosted electronic file, and storing said hosted electronic file or files on a memory of the computing device as a stored electronic file or files;

displaying a stored electronic file on the screen of the computing device when the computing device is displaying a home screen.

Preferably at least one hosted electronic file is a static image file, more preferably in JPG, GIF, TIF, TIFF or PDF format.

In a preferred embodiment, after the downloading step, the communications link is severed for a first time interval. The first time interval may optionally be in the order of a day, a week, or a month.

Preferably the displaying step ends as soon as another application is launched on the computing device. Alternatively, the displaying step ends a specified second time period after an application is launched. In a preferred embodiment, the second time period is three seconds.

In a preferred embodiment, the displaying step displays the stored electronic file floating over the home screen, such that it can be moved by a user to reveal the home screen underneath.

Preferably the displaying step is repeated multiple times. In a preferred embodiment, the repeated displaying step displays a different stored electronic file from that displayed in the immediately preceding displaying step. In an alternative embodiment, the same stored electronic file is displayed a specified number of times before another stored electronic file is displayed.

Preferably the method further includes the step of receiving at least one display precondition, such that the step of displaying the stored electronic file will not take place until every display precondition has been met. In a preferred embodiment, the display precondition is a specified third time period having elapsed since the displaying step last took place.

In a preferred embodiment, the method further includes the steps of:
recording in a log file the number of times the or each stored electronic file is displayed; and
after the step of establishing the communications link, uploading the log file to the remote server.

Preferably the method also includes recording in the log file the duration for which the or each stored electronic file is displayed. Optionally additional information is recorded in the log file, consisting of the time, and/or the location of the computing device, at which the or each stored electronic file is displayed.

In a preferred embodiment, the remote server is configured to receive the log file, and to assign to a user account associated with the computing device a loyalty score based on the number of times the or each stored electronic file is displayed and optionally the duration for which the or each stored electronic file is displayed (if this information is contained in the log file). Preferably the remote server periodically assigns a reward based on the loyalty score. In a highly preferred embodiment the reward is a right to participate in a prize draw or other game of chance. Optionally one or more rewards may be randomly assigned to a user account independent of any loyalty score.

In a preferred embodiment, the or each hosted electronic file is associated with a hosted information file, and the downloading step includes downloading and storing the hosted information file associated with the or each hosted electronic file. Preferably the or each hosted information file includes a priority ranking for the associated hosted electronic file. More preferably, in determining which stored electronic file to display, the system accesses the stored information file for each stored electronic file and the log file, and selects an electronic file based on the priority ranking and number of times already viewed for each stored electronic file.

In a further, alternative aspect of the present invention, there is provided a method of displaying a file on a screen of a computing device, including:
establishing a communications link with a remote server, said server hosting at least one hosted electronic file;
downloading from the remote server at least one hosted electronic file, and storing said hosted electronic file or files on a memory of the computing device as a stored electronic file or files;
displaying a stored electronic file on the screen of the computing device for a preselected time interval whenever a new application is launched on the computing device.

Preferably at least one hosted electronic file is a static image file.

In a preferred embodiment, the communications link is severed for a first time interval.

Preferably the preselected time interval is three seconds.

The method may also include the steps of:
recording in a log file the number of times the or each stored electronic file is displayed; and
after the step of establishing the communications link, uploading the log file to the remote server.

In a preferred embodiment, the remote server is configured to receive the log file, and to assign to a user account associated with the computing device a loyalty score based on the number of times the or each stored electronic file is displayed. Preferably the remote server periodically assigns a reward based on the loyalty score. More preferably the reward is a right to participate in a prize draw.

Preferably the or each hosted electronic file is associated with a hosted information file, and the downloading step includes downloading and storing the hosted information file associated with the or each hosted electronic file. More preferably the or each hosted information file includes a priority ranking for the associated hosted electronic file.

The present invention further provides a system configured to implement any one of the methods described above.

### BRIEF DESCRIPTION OF THE DRAWINGS

By way of non-limiting example only, a preferred embodiment of the invention is described in detail below with reference to the accompanying drawings, in which:

FIG. 1 is a block diagram of a smart phone configured in a first preferred embodiment to carry out the invention;

FIG. 2 is a schematic diagram of part of the system according to the first preferred embodiment of the present invention; and

FIG. 3 is the smart phone of FIG. 1 displaying an electronic file in accordance with the first preferred embodiment of the present invention.

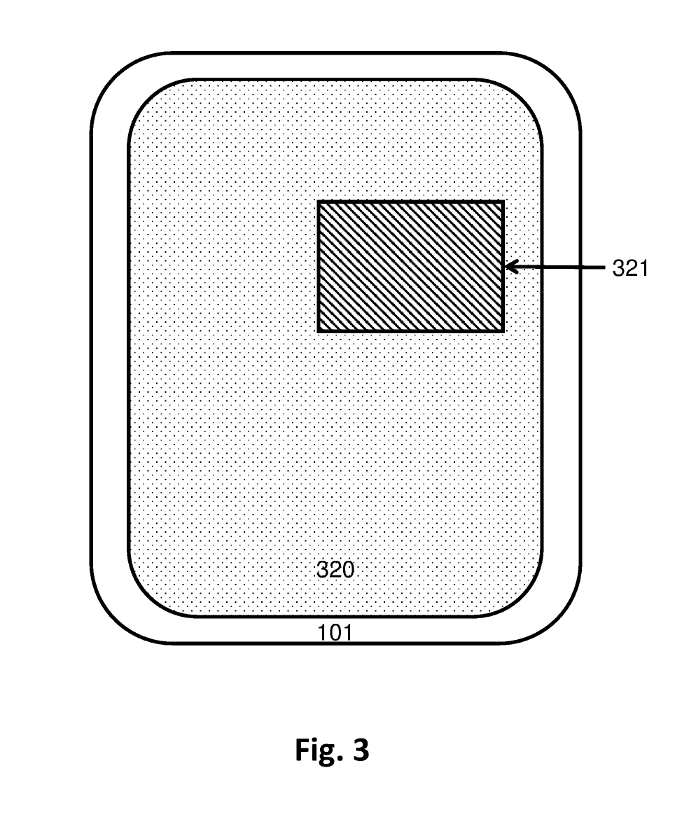

### BEST METHOD OF PERFORMING THE INVENTION

By way of example, the present invention is now described in detail by reference to a preferred embodiment in which the computing device is a smart phone 101.

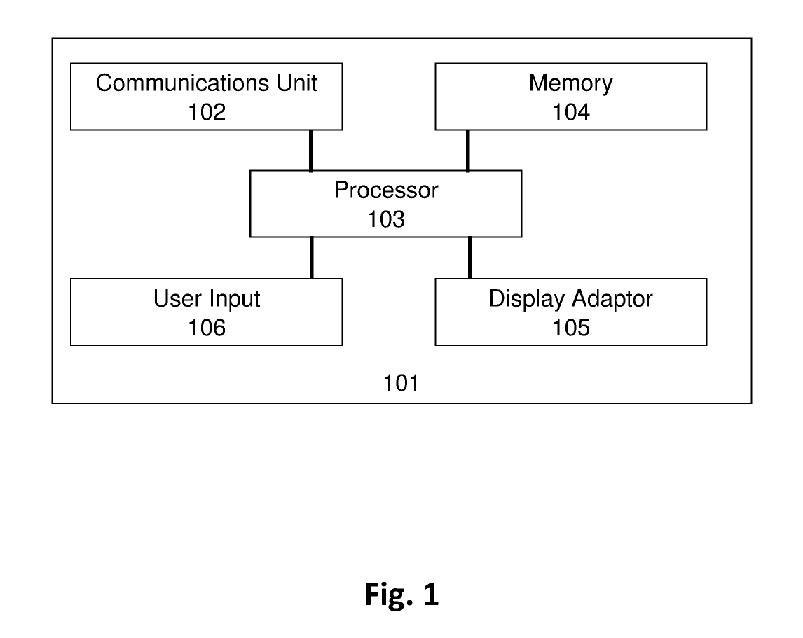

As shown in FIG. 1, the smart phone 101 includes a communications unit 102, which may be a WLAN adaptor or cellular phone communications unit. Communications unit 102 is connected to a central processor 103, which is connected to memory 104 and a display adaptor 105 for displaying material on a display screen. A user input 106 connected to the processor 103 may, in this embodiment, be a touch screen on the smart phone 101.

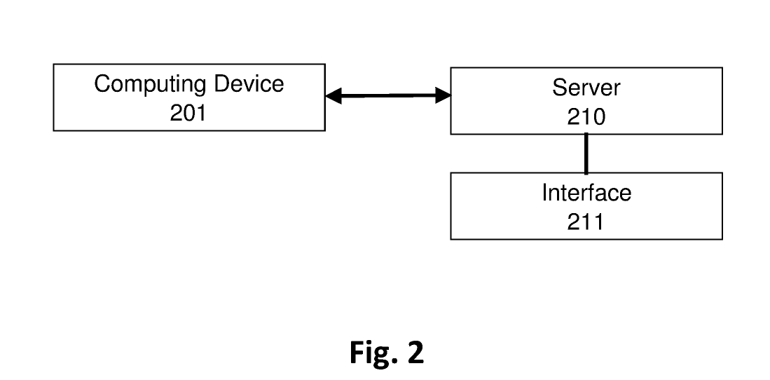

As shown in FIG. 2, the computing device 201 (in this case smart phone 101) communicates via communications unit 102 with a server 210 loaded with at least one hosted electronic file. In this embodiment, there are multiple hosted electronic files, each in the form of a static image, such as a JPEG or GIF. Preferably each file represents an advertisement for a product or service. The files are transmitted from the server 210 to the smart phone 101 and stored in its memory 104 as stored electronic files.

The home screen 320 of a smart phone 102 may include a background image, and a number of icons in a graphical user interface (“GUI”), each of which allows a user to select and launch an application to run on the smart phone.

When the smart phone 101 is on its home screen 320, the system displays one stored electronic file as an electronic billboard 321 in a window over the top of part of the home screen 320. Using user input 106, the user can move the location of electronic billboard 321 relative to the home screen 320 underneath it, so as to access icons which may be hidden behind the electronic billboard 321. When the user launches or switches to an application on the smart phone 101, the electronic billboard 321 disappears, so that it does not interfere with the running of any other application on the smart phone.

In an alternative embodiment, the electronic billboards 321 remains visible for a set period (e.g. 3 seconds) after an application is launched, before disappearing. In the case where an application displays a splash screen during loading, displaying the electronic billboard during this time will not interfere with the running of that application.

In this preferred embodiment, every time the electronic billboard 321 is displayed, the system records an entry in a log file specifying which stored electronic file was displayed, and for how long.

The user is able to configure the system to specify whether the electronic billboard 321 appears every time the smart phone 101 displays the home screen 320, or whether the electronic billboard 321 appears at regular time intervals; the size of the electronic billboard 321; whether the electronic billboard 321 disappears after a set period of time; how many electronic files the system downloads to cycle; and how often the library of electronic files stored in the memory 104 and available to the system is refreshed by establishing a communications link with server 210 and downloading new hosted electronic files.

Once the electronic files have been downloaded from server 210 and stored in the memory 104, the system operates off-line. Thus, unlike many prior art systems, it does not need to use communications unit 102 in order to display appropriate content on electronic billboard 321, reducing both power and bandwidth use.

Periodically (e.g. once a week) the smart phone 101 does communicate via communications system 102 with the server 210. At this stage, the library of stored electronic files in the memory 104 of the smart phone 101 can be updated by downloading new hosted electronic files from server 210, and deleting stored electronic files that are no longer available as hosted electronic files on server 210.

The system may also send information to the server 210. This may include information from the log file, as well as anonymised demographic information relating to the user of the smart phone 101, such as gender, age bracket. This data may be used for analytical purposes.

Advertisers may submit to the server 210 electronic files they want to have displayed on the electronic billboard, in exchange for a fee. The server 210 may provide advertisers with anonymised demographic data collected from the smart phones 101 of users of the system via an interface 211. Advertisers may specify a particular target age group or other demographic, and the server 210 will provide their hosted electronic files only to the library of smart phone accounts meeting the specified demographic criteria.

The hosted electronic files may also be assigned a priority level. When the system downloads a hosted electronic file, it also downloads an information file relating to that hosted electronic file, and containing the priority level. Files having a higher priority level will be displayed by the system on the electronic billboard more often. Advertisers may pay a premium for a higher priority level.

In a preferred embodiment, information is also sent to the server 210 including an account identifier for the user of the smart phone 101, together with information from the log file as to how many electronic files they have viewed since last syncing with the server 210, and for how long. A reward algorithm operating on server 210 then assigns to the number and duration of views a loyalty value. At regular intervals (e.g. monthly), the reward algorithm adds together the loyalty values for all user accounts, and generates at least one winner, with accounts with a higher loyalty value having a higher chance of winning. Alternatively or additionally, spot prizes may also be awarded independent of loyalty value. The or each winner is then notified, and may receive a reward. By providing a rewards system such as this, smart phone users are encouraged to use the electronic billboard.

The embodiments shown and described in detail herein are by way of example only. The present invention is intended to include such modifications and variations thereto as may be obvious to one skilled in the art.

1. A method of displaying a file on a screen of a computing device, including:
establishing a communications link with a remote server, said server hosting at least one hosted electronic file;
downloading from the remote server at least one hosted electronic file, and storing said hosted electronic file or files on a memory of the computing device as a stored electronic file or files;
displaying a stored electronic file on the screen of the computing device when the computing device is displaying a home screen.

2. The method according to claim 1, wherein at least one hosted electronic file is a static image file.

3. The method according to, claim 1, wherein, after the downloading step, the communications link is severed for a first time interval.

4. The method according to claim 1, wherein the displaying step ends as soon as another application is launched on the computing device.

5. The method according to claim 1, wherein the displaying step ends a specified second time period after an application is launched.

6. The method according to claim 5, wherein the second time period is three seconds.

7. The method according to claim 1, wherein the displaying step displays the stored electronic file floating over the home screen, such that it can be moved by a user to reveal the home screen underneath.

8. The method according to claim 1, wherein the displaying step is repeated multiple times.

9. The method according to claim 8, wherein the repeated displaying step displays a different stored electronic file from that displayed in the immediately preceding displaying step.

10. The method according to claim 8, wherein the same stored electronic file is displayed a specified number of times before another stored electronic file is displayed.

11. The method according to claim 1, further including the step of receiving at least one display precondition, such that the step of displaying the stored electronic file will not take place until every display precondition has been met.

12. The method according to claim 11, wherein the display precondition is a specified third time period having elapsed since the displaying step last took place.

13. The method according to claim 8, further including the steps of:
recording in a log file the number of times the or each stored electronic file is displayed; and
after the step of establishing the communications link, uploading the log file to the remote server.

14. The method according to claim 13, further including recording in the log file at least one item of additional information selected from the list consisting of: the duration for which the or each stored electronic file is displayed, the time at which the or each stored electronic file is displayed, and the location of the computing device at which the or each stored electronic file is displayed.

15. The method according to claim 13, wherein the remote server is configured to receive the log file, and to assign to a user account associated with the computing device a loyalty score based on the number of times the or each stored electronic file is displayed.

16. The method according to claim 15, wherein the remote server periodically assigns a reward based on the loyalty score.

17. The method according to claim 16, wherein the reward is a right to participate in a prize draw.

18. The method according to claim 1, wherein the or each hosted electronic file is associated with a hosted information file, and the downloading step includes downloading and storing the hosted information file associated with the or each hosted electronic file as a stored information file.

19. The method according to claim 18, wherein the or each hosted information file includes a priority ranking for the associated hosted electronic file.

20. The method according to claim 19 wherein the displaying step is repeated multiple times, further including the steps of:
recording in a log file the number of times the or each stored electronic file is displayed; and
after the step of establishing the communications link, uploading the log file to the remote server,
wherein, in determining which stored electronic file to display, the system accesses the stored information file for each stored electronic file and the log file, and selects stored electronic file based on the priority ranking and number of times already viewed for each stored electronic file.

21. A method of displaying a file on a screen of a computing device, including:
establishing a communications link with a remote server, said server hosting at least one hosted electronic file;
downloading from the remote server at least one hosted electronic file, and storing said hosted electronic file or files on a memory of the computing device as a stored electronic file or files;
displaying a stored electronic file on the screen of the computing device for a preselected time interval whenever a new application is launched on the computing device.

22. The method according to claim 21, wherein at least one hosted electronic file is a static image file.

23. The method according to claim 21, wherein, after the downloading step, the communications link is severed for a first time interval.

24. The method according to claim 21, wherein the preselected time interval is three seconds.

25. The method according to claim 23, further including the steps of:
recording in a log file the number of times the or each stored electronic file is displayed; and
after the step of establishing the communications link, uploading the log file to the remote server.

26. The method according to claim 25, wherein the remote server is configured to receive the log file, and to assign to a user account associated with the computing device a loyalty score based on the number of times the or each stored electronic file is displayed.

27. The method according to claim 26, wherein the remote server periodically assigns a reward based on the loyalty score.

28. The method according to claim 27, wherein the reward is a right to participate in a prize draw.

29. The method according to claim 21, wherein the or each hosted electronic file is associated with a hosted information file, and the downloading step includes downloading and storing the hosted information file associated with the or each hosted electronic file as a stored information file.

30. The method according to claim 29, wherein the or each hosted information file includes a priority ranking for the associated hosted electronic file.

31. A system configured to implement the method as claimed in claim 1.

32. The method according to claim 8, wherein, after the downloading step, the communications link is severed for a first time interval.

33. The method according to claim 9, wherein, after the downloading step, the communications link is severed for a first time interval.

34. The method according to claim 10, wherein, after the downloading step, the communications link is severed for a first time interval.

35. The method according to claim 11, wherein, after the downloading step, the communications link is severed for a first time interval.

36. The method according to claim 15, wherein, after the downloading step, the communications link is severed for a first time interval.

37. The method according to claim 18, wherein, after the downloading step, the communications link is severed for a first time interval.

38. The method according to claim 19, wherein, after the downloading step, the communications link is severed for a first time interval.

39. The method according to claim 20, wherein, after the downloading step, the communications link is severed for a first time interval.

40. The method according to claim 14, wherein the remote server is configured to receive the log file, and to assign to a user account associated with the computing device a loyalty score based on the number of times the or each stored electronic file is displayed.

41. The method according to claim 40, wherein, after the downloading step, the communications link is severed for a first time interval.

42. The method according to claim 29, wherein, after the downloading step, the communications link is severed for a first time interval.

43. The method according to claim 30, wherein, after the downloading step, the communications link is severed for a first time interval.

44. A system configured to implement the method as claimed in claim 3.

45. A system configured to implement the method as claimed in claim 21.

46. A system configured to implement the method as claimed in claim 23.
